(19) United States
(12) Patent Application Publication
(10) Pub. No.: US 2007/0009671 A1
(43) Pub. Date: Jan. 11, 2007

(54) Process and device for positioning the mask

(76) Inventor: Dieter Manz, Schlaitdorf (DE)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 11/407,343

(22) Filed: Apr. 19, 2006

(30) Foreign Application Priority Data
Apr. 20, 2005 (EP) 05008663

(51) Int. Cl. B05D 1/32

(52) U.S. Cl. 427/468

(57) ABSTRACT

Aspects of the invention are directed to a device and a method for arranging/removing and aligning masks on substrates to be coated, especially for the micro-structuring of organic, electroluminescent materials (OLED) on preferably large-surface substrates, especially screens, displays and the like. In one version a process includes providing a substrate on a substrate carrier, the substrate carrier having magnets arranged peripherally around a substrate receiver area, holding the mask using electromagnets on a holding assembly moveable in several dimensions by a first movement device, determining relative positions of the mask and substrate to each other, aligning the substrate and mask with each other by actuating the first movement device such that the mask is moved relative to the substrate, if a misorientation has been determined, depositing the mask on the substrate by moving at least one of the holding assembly and the substrate carrier, and deactivating the electromagnets and holding the mask on the substrate by the magnets of the substrate carrier.

### RELATED APPLICATION

This application relates to U.S. patent application Ser. No. ______ entitled MAGNETIC MASK HOLDER (Attorney Docket No. A2022-700110), by Dieter Manz, filed on even date herewith, and U.S. patent application Ser. No. ______ entitled CONTINUOUS OLED COATING MACHINE (Attorney Docket No. A2022-700210), by Dieter Manz, Marcus Bender, Uwe Hoffmann, Dieter Haas, Ulrich Englert, Heino Lehr and Achim Garke, filed on even date herewith. Both of these related applications are incorporated herein by reference.

### BACKGROUND OF INVENTION

The present invention relates to a process and a device for arranging/removing and aligning masks on substrates to be coated, especially for the micro-structuring of organic electroluminescent materials (OLED) on preferably large-surface substrates, especially screens, displays and the like in a vacuum.

In the production of so-called OLED displays or screens, which utilize the light-emitting properties of organic, electroluminescent materials (OLED), it is necessary to apply organic, electroluminescent materials with a corresponding micro-structure on a transparent substrate, such as glass, such that the electroluminescent structures may be actuated by corresponding electrode layers and stimulated to emit light.

The micro-structured, organic, electroluminescent materials are usually applied by means of vacuum-coating processes, with the microstructures usually generated by corresponding shadow masks. These masks need to be placed on the substrates in a suitable manner, to be transported along with them through the corresponding coating chambers, and then removed again from them in order that, following possible cleaning, they may be reused.

On account of the small dimensions of the micro-structuring, very accurate positioning of the masks is essential, especially when so-called RGB displays are manufactured in which pixel areas for red, green and blue light have to be generated in close proximity to each other for chromatic presentation on the display. In addition, the vacuum-coating processes require a high degree of purity, such that it must be ensured that the handling devices for the masks do not generate any unnecessary particles.

A magnetic holding device for foil masks is described in DE 297 07 686 U 1. In the described holding device, a foil mask is arranged on a substrate carrier by means of positioning pins on which said mask, in turn, the substrate to be coated lies. Above the substrate is an arrangement of magnets that serves to press the full surface of the ferromagnetic mask against the substrate, which is provided between mask and magnet arrangement. In such an arrangement for a mask holder, the mechanical attachment of the mask to the substrate carrier promotes the generation of undesirable particles and, moreover, such an arrangement is unfavourable for simple, quick and precise arrangement and removal of the mask from the substrate.

Further, EP 1 202 329 A 2 refers to a mask arrangement in which a mask is pressed across its full surface against the substrate by means of an arrangement of magnets behind the substrate carrier. The masks described therein may feature a peripheral frame by means of which the mask is laterally clamped in order to impart a certain degree of stability to the thin foil from which the mask is usually made. Although such magnetic attraction of the mask against the substrate enables full contact to be obtained between the mask and the substrate and hence freedom from blisters, and sharp coating edges, such an arrangement is not optimal for rapid, precise handling with regard to mask changing, especially under vacuum conditions. Moreover, the magnets merely serve the purpose of creating full-surface, blister-free contact between the mask and the substrate, but not that of holding in a dynamic system in which the substrate on the substrate carrier is moved with the mask through the coating area.

### SUMMARY OF INVENTION

At least one aspect of the invention is directed to a process and a device for mask changing, especially for arrangement and alignment in dynamic vacuum-coating processes for in-line production of OLED screens or displays, that avoid disadvantages of the prior art and especially guarantee a precise, rapid and simple possibility of mask changing, and a secure and reliable arrangement of the mask at the (dynamic) substrate moved during coating. Especially, the corresponding devices for mask changing are to be easy to manufacture and simple to operate.

In accordance with a first aspect, the present invention is based on the knowledge that handling of the mask, especially in a vacuum, can be realized advantageously by means of electromagnets that can be switched on and off such that, in a simple manner, a corresponding force can be exerted on the masks and then switched off again. For this reason, a device has been created in which a first movement device and a holding assembly are provided, with the holding assembly capable of picking up and depositing the mask, while the first movement device is provided for aligning the mask relative to the substrate. The holding assembly features electromagnets with which a magnetic mask or a mask with magnetic edge or frame can be picked up and deposited again in a simple manner. In this regard, the electromagnets are preferably arranged at a holding plate or a holding frame around a central area that is free of electromagnets, such that the mask can be picked up by its edge or its peripheral frame. For one thing, this has the advantage of ensuring secure, stable receiving of the mask in the mask-arranging and positioning device in combination with a low number of electromagnets and, for another, many different masks can be handled, since, in the case of non-magnetic masks, a corresponding magnetic frame need only be provided.

Preferably, the electromagnets are equally spaced from each other in the form of a ring, square or polygon in a closed strip, such that the mask can be picked up uniformly.

The movement device, which facilitates movement of the holding assembly relative to the substrate, preferably comprises several independent means of movement, especially means of movement in at least three independent directions of movement. Preferably, the means of movement are formed by linear drives and/or rotary drives, which facilitate, along the three perpendicular spatial directions, i.e. the x, y, z coordinates, corresponding movements of the holding assembly on one hand and/or rotary movements on the other.

In accordance with a further aspect of the invention, for which protection is also sought independently, a second movement device is provided which, independently of the first movement device, facilitates approaching of the substrate towards the mask.

For this purpose, both the second movement device and the substrate carrier feature corresponding coupling means, which facilitate connection and release in a simple manner.

In a preferred embodiment, the second movement device comprises several means of movement, especially linear drives.

Through the decoupling of the alignment of the mask relative to the substrate and approaching of substrate and mask, it is possible, especially in connection with the magnetic transfer and holding during dynamic coating, to achieve particularly exact, accurate masking.

Spindle drives that permit particularly gentle, smooth and uniform motion are preferably provided for the movements of the holding assembly or the mask, especially towards the substrate and away from it, or, conversely, for movement of the substrate towards the mask and away from it again.

For controlling the movement device, a monitoring and/or control device is preferably provided, with the monitoring device establishing mispositioning of the mask relative to the substrate and the corresponding control unit making corresponding corrections by actuating the first movement device. For this purpose, the monitoring device preferably features at least two CCD cameras, which bring the corresponding markings at the substrate and mask into alignment or register.

Since mask changing preferably occurs in the vacuum area of the vacuum-coating machine, the device is advantageously formed such that it can be arranged at one vacuum-chamber wall, with the drive(s) of the movement devices or at least of parts of the means of movement preferably arranged outside the vacuum chamber in order that introduction of impurities into the vacuum area may be diminished.

Preferably, the device for mask changing is formed such that a substrate-carrier holding position for the substrate carrier is provided which is predefined such that the substrate has already been pre-positioned relative to the mask.

Furthermore, the substrate carrier preferably features magnets, namely permanent magnets or electromagnets, which hold the mask on or relative to the substrate during the coating process. Since, in this regard, masks with magnetic edge or frame are advantageously used, the magnets of the substrate carrier are arranged peripherally around the substrate-receiver area in a corresponding manner to the holding assembly, such that when the mask is transferred from the holding assembly to the substrate carrier and vice versa, the mask is held in the same areas, albeit on opposite sides.

For arranging the magnets at the substrate carrier, the latter advantageously features a mask-holding frame at which the magnets are arranged on the reverse side of the substrate carrier, opposite the substrate.

In a preferred embodiment, the magnets at the substrate carrier, and the electromagnets at the holding assembly are aligned with each other such that they are arranged exactly above each other during the transfer, with the result that, by means of corresponding superposition of a magnetic field, the holding effect of the magnets of the substrate carrier can be reduced or switched off.

Preferably, the holding assembly of the transfer device features a holding plate or a rectangular, polygonal or annular holding frame which, for instance, makes it possible that, in the central area, the CCD cameras of the monitoring unit have an unobscured view of the mask.

Transfer of the mask proceeds in such a manner that first a substrate on a substrate carrier, in which preferably magnets are spaced equidistantly from each other around the substrate receiver area, is made available in a substrate-carrier holding position opposite the mask-holding assembly. The mask is arranged beforehand, simultaneously or subsequently at the electromagnets of the traversable holding assembly, and the monitoring and control unit determines the relative positions of mask and substrate, especially with regard to the lateral position, that is with regard to, for example, the x/y coordinates of a horizontal plane in the event that the substrate is transported horizontally through the coating machine. Where a misalignment or mispositioning is ascertained, alignment of substrate and mask is effected by actuation of the first movement device, i.e. preferably by movement of the mask, with movement of the substrate also conceivable. Alignment proceeds, for example, by means of translatory or linear movements in two mutually perpendicular directions, e.g. the x/y direction, and/or a rotary movement about a third perpendicular axis (z axis). Additionally, further movement directions and/or types can be provided, e.g. a linear movement in the z direction.

After corresponding alignment, the mask is deposited on the substrate, and more precisely preferably by actuation of the second movement device, such that mask and substrate are moved towards each other. In this regard, it is clear that the movement of mask and substrate with regard to mutual approach and alignment can also be swapped.

As soon as the mask is arranged on the substrate, the electromagnets of the holding assembly are deactivated and the mask is held on the substrate by the magnets of the substrate carrier. The substrate furnished with the mask is then available on the substrate carrier for transport through the coating machine and for corresponding coating. Naturally, the mask can also be removed again from the substrate or substrate carrier by the same device, in which case corresponding alignment can naturally be eschewed.

### BRIEF DESCRIPTION OF DRAWINGS

Further advantages, characteristics and features of the present invention are apparent from the following detailed description of an embodiment using the enclosed drawings. The purely schematic diagrams show the following:

FIG. 1 shows a side view of a mask-application station, with the mask in the raised state;

FIG. 2 shows the mask-application station from FIG. 1 with mask arranged at the substrate;

FIG. 3 shows the mask-application station of FIG. 1 and FIG. 2 with the mask deposited on the substrate; and

FIG. 4 shows a plan view of a mask with frame.

### DETAILED DESCRIPTION

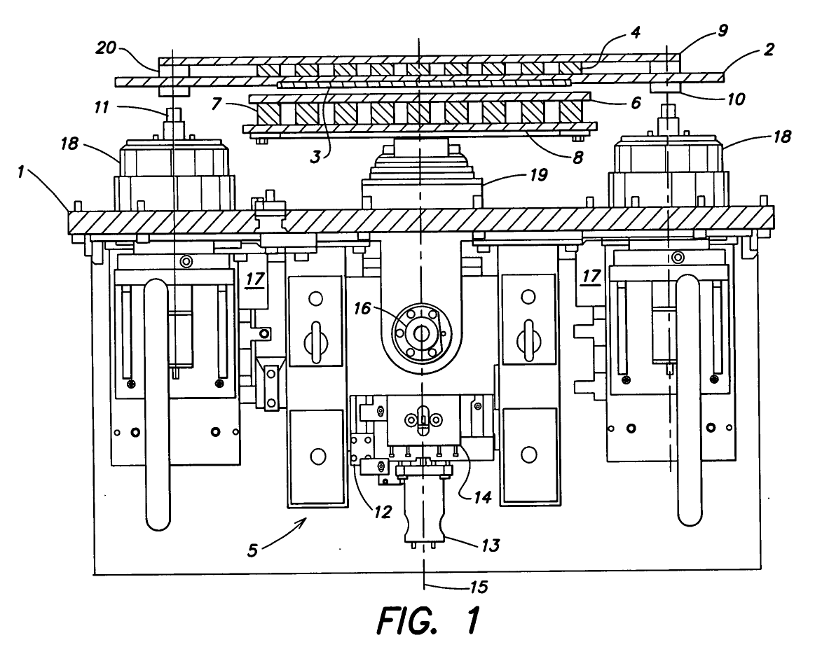

FIG. 1 is a lateral view and partial cross-sectional view of a mask-application station for a vacuum chamber of a vacuum-coating machine, especially for the continuous (in-line) coating of transparent substrates with organic, electroluminescent materials for the production of OLED displays or screens.

FIG. 1 shows a cross-section through a chamber wall or a mounting plate 1, which can be inserted into the chamber wall, whereby, in the vacuum chamber, i.e. above the mounting plate I of FIG. 1, a substrate carrier 2 is shown with a substrate 3 arranged on it, which can be transported through the vacuum chamber by means of transport or conveyor devices not shown.

In the state shown in FIG. 1, the substrate is located above a mask-application station with mask-positioning device 5, with the aid of which mask 6 can be arranged and aligned on substrate 3.

The mask-positioning device 5 features a large number of electromagnets 7, which are arranged peripherally around a holding plate or frame 8. The holding frame 8 is, in turn, connected via a vacuum-tight guide 19 to different drives 12, 13, 14 and 16 that facilitate movement of the holding plate or frame 8 relative to the substrate carrier 2 or the substrate 3. In this regard, movement is permitted by the horizontal drive 12 in the horizontal direction, by the vertical drive 16 in the vertical direction, i.e. out of the plane of the diagram, and by the axial drive 13 in the axial direction, i.e. in the direction of the axis 15. Additionally, a rotary drive 14 is provided, which permits rotation of the holding plate 8 about the axis 15. On account of the drives 12, 13, 14 and 16, the holding plate 8 can thus be brought into any position relative to the substrate carrier 2.

Apart from the mask-positioning device 5, a second movement device is provided in the form of preferably several, and, in the example embodiment, a total of 4, lifting devices 18 arranged in a square for gripping the corners of the rectangular substrate carrier. The ends of the lifting devices 18 each have coupling elements 11 which interact with the substrate carrier couplings 10 such that the substrate carrier 2 can be connected with the lifting devices 18 such that these can move the substrate carrier 2.

The lifting mechanism or drive 18 may comprise a hydraulic or pneumatic lifting cylinder or, as in the preferred embodiment, also a spindle drive, which is characterised by particularly uniform, exact and smooth movement. The axial drive 13 or the other drives may be formed in the same manner.

Apart from the lifting drives 18 and the mask-positioning device 5, additionally provided on the mounting plate I are CCD cameras 17, preferably at least two cameras, which can monitor the positioning of the mask 6 on the substrate 3 each via a window element. The CCD cameras form a monitoring unit, which checks the exact positioning of the mask relative to the substrate. In the event of mispositioning, a control unit (not shown) is activated, which controls the movement of the mask-positioning device 5. By means of the drives 12, 14 and 16, the mask 6 can be positioned exactly, as this facilitates alignment of the holding frame 8 in two mutually perpendicular directions, and a rotation. Additionally, the axial drive 13 facilitates positional adjustment of the distance of the mask 6 relative to the substrate 3. Overall, the result is that the mask-positioning device 5 affords the possibility of exact positioning of the mask in three independent spatial directions.

The substrate carrier 2 comprises, peripherally around the area in which the substrate 3 comes to lie, a large number of magnets 4 whose positions correspond with the electromagnets 7. This means that, when adherence to the provided substrate and mask positions is observed, during transfer of the mask to the substrate 3, the electromagnets 7 and the magnets 4 of the substrate carrier 2 are exactly opposite each other or their longitudinal axes are arranged on one axis. The magnets 4 can be both permanent magnets and electromagnets. The magnets 4 are arranged at the reverse side of the substrate carrier 2 at a mask-holding frame 9, which in turn is arranged via spacers 20 on the substrate-holding plate of the substrate carrier 2. The mask-holding frame 9 may in this regard be attached in any suitable manner, especially releasably, to the substrate-holding plate of the substrate carrier 2.

The mask-holding frame 9 can be formed both as an annular frame and a continuous plate. Especially, the mask-holding frame also serves as a magnetic yoke for the magnets 4 arranged on it.

The annular or frame-like arrangement of the magnets 4, 7 around or along the edge of the receiver area for the substrate 3 effects uniform and, for dynamic coating, sufficiently firm holding of the mask 6 with magnetic forces sufficiently large enough for handling the thin, foil-like masks without damaging them.

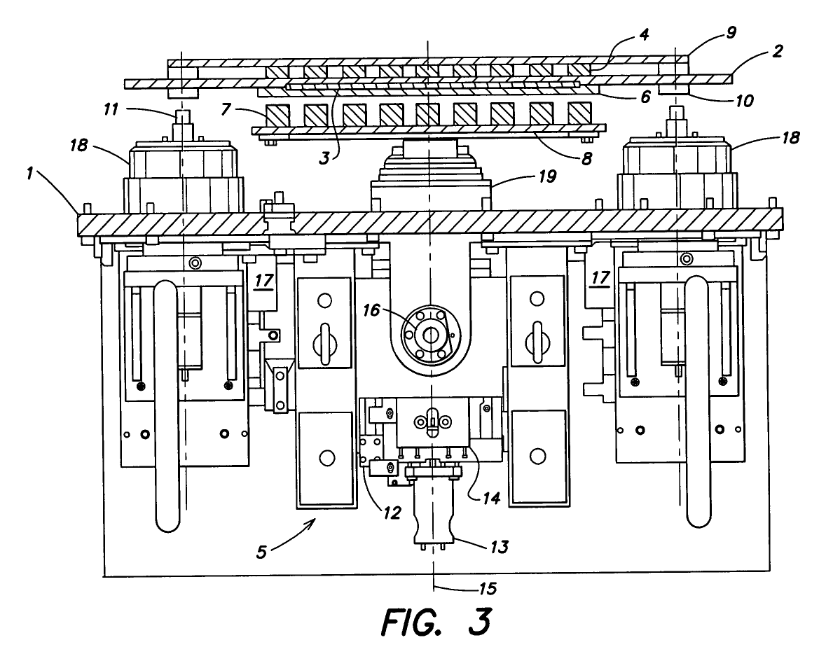

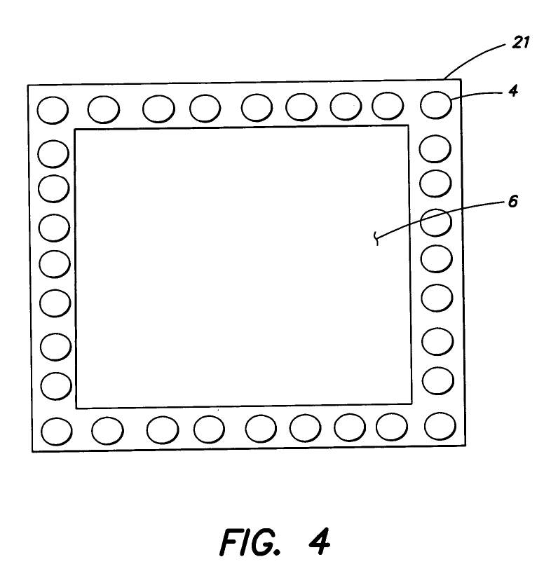

The transfer of the mask to the substrate proceeds as depicted in FIGS. 1 to 3 in such a manner that the mask 6 is first passed by a mask feed to the mask-positioning arrangement 5, said mask 6 featuring a peripheral magnetic frame or edge 21 (see FIG. 4), which corresponds to the peripherally or annularly arranged electromagnets on the holding frame 8 of the mask-positioning device 5, such that mask 6 can be held by its frame 21 or edge by means of the electromagnets 7 of the holding plate 8 on corresponding activation of the electromagnets 7.

As soon as the substrate 3, on which the mask 6 is to be arranged, is arranged in a correspondingly pre-defined position relative to the mask-positioning device 5, exact lateral alignment of the mask 6 relative to substrate 3, i.e. alignment in relation to the x/y coordinates, is adjusted via the drives 12, 14 and 16 with the aid of the CCD cameras 17.

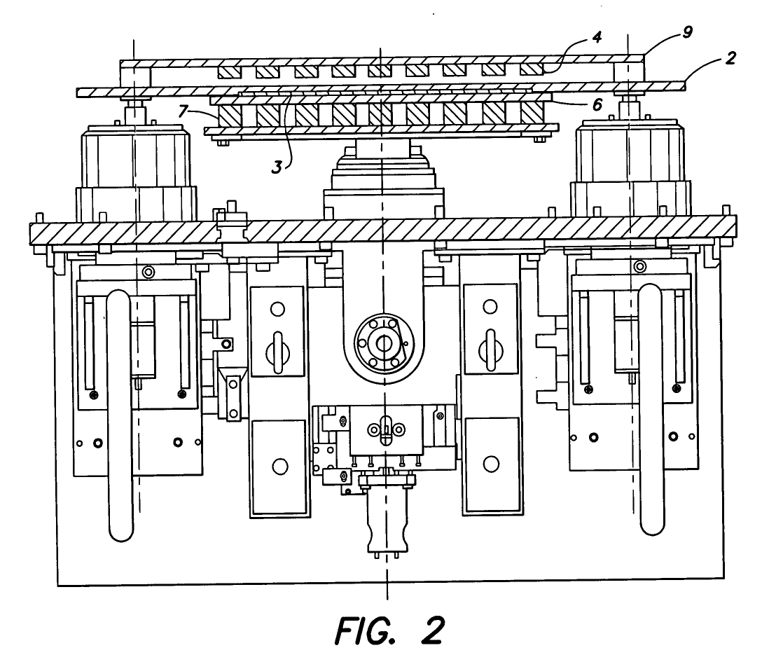

When the mask 6 is aligned in the correct position above the substrate 3, i.e. full register or congruence identity is achieved in the projection, the substrate carrier 2 with the substrate 3 is gripped by the coupling elements 11 of the lifting devices 18 at the substrate-carrier coupling 10 and, as illustrated in FIG. 2, is traversed by means of the lifting devices 18 to the mask 6 from behind such that the magnetic frame or edge of the mask 6 comes to lie over the magnets 4 of the substrate carrier, and the mask 6 comes to lie over the substrate 3. Additionally or alternatively, the movement can be effected perpendicularly to the substrate or mask plane by axial drive 13 as well.

Thereafter, the electromagnets 7 are deactivated or switched off and the substrate 3 is traversed upwards by means of the lifting drives 18.

The substrate 3 with the mask 6 is then ready for further transport through the vacuum-coating machine, with the magnets 4 of the substrate carrier 2 holding the mask 6 on the substrate 3 held by the frame 21 or the edge.

This is particularly clear in the plan view of FIG. 4, which shows the mask 6 and the frame or edge 21 of the mask 6 and the magnets 4, which are located beneath the frame or the edge 21 on the substrate carrier 2 arranged there under (not shown). The chosen arrangement for holding the mask via magnets 4 at the substrate carrier, especially in an annular or frame-shaped arrangement around or along the edge of the substrate and the corresponding provision of a frame or edge on the mask for interaction with the magnets, facilitates simple handling of the mask, secure holding of the mask against the substrate or substrate carrier during dynamic coating and a major reduction of the particles generated during handling of the mask, i.e. raising and lowering of the mask. Further, inexpensive design and construction of the entire system is facilitated.

Through the use of electromagnets for raising and lowering or holding the mask by its frame or edge in the positioning device, simple transfer is guaranteed, with particularly uniform and smooth movement and transfer obtainable, especially when a spindle drive is used for vertical adjustment of the positioning device and/or the lifting devices for the substrate carrier. The mask 6 and the frame 20 can be formed both as one piece and several pieces, with the multi-piece designs being described as a frame, and the one-piece designs being described as an edge.

Although arrangement of the mask on the substrate only is described here, removal of the mask from the substrate is naturally possible in the reverse manner with the same device. The alignment of the mask merely needs to be eschewed.

### LIST OF TERMS

1 Chamber wall
2 Substrate carrier
3 Substrate
4 Magnets
5 Mask-positioning device
6 Mask
7 Electromagnets
8 Holding plate or frame
9 Mask-holding frame
10 Substrate-carrier coupling
11 Gripping device
12 Horizontal drive
13 Axial drive
14 Rotary drive
15 Positioning axis
16 Vertical drive
17 Camera
18 Lifting device
19 Guide
20 Spacer
21 Mask frame

Having thus described several aspects of at least one embodiment of this invention, it is to be appreciated various alterations, modifications, and improvements will readily occur to those skilled in the art. Such alterations, modifications and improvements are intended to be part of this disclosure, and are intended to be within the spirit and scope of the invention. Accordingly, the foregoing description and drawings are by way of example only.

What is claimed is:

1. A process for arranging/removing and aligning a mask on a substrate to be coated, the process comprising:
providing a substrate on a substrate carrier, the substrate carrier having magnets arranged peripherally around a substrate receiver area on its rear side;
holding the mask using electromagnets on a holding assembly moveable in several dimensions by a first movement device;
determining relative positions of the mask and substrate to each other;
aligning the substrate and mask with each other by actuating the first movement device such that the mask is moved relative to the substrate, if a misorientation has been determined;
depositing the mask on the substrate by moving at least one of the holding assembly and the substrate carrier, the substrate carrier being moved by a second movement device; and
deactivating the electromagnets and holding the mask on the substrate by the magnets of the substrate carrier.

2. The process of claim 1, wherein the mask includes a magnetic edge or frame, which corresponds with the magnets of the substrate carrier.

3. The process of claim 1, wherein the position of the mask above the substrate is determined automatically by a monitoring device having at least one CCD camera.

4. The process of claim 1, wherein alignment of the mask is achieved using at least one of independent linear movements and rotary movements.

5. The process of claim 1, wherein depositing the mask on the substrate is achieved by at least one of linear movement of the holding assembly and the second movement device using at least one spindle drive.

6. The process of claim 1, wherein the substrate is moved towards a back side of the mask.

7. The process of claim 1, wherein determining the relative positions includes determining relative lateral positions, and wherein aligning the mask and substrate includes laterally moving at least one of the mask and the substrate.

8. A device for arranging/removing and aligning a mask on a substrate to be coated, the device comprising:
a holding assembly for picking up and depositing a mask on a surface of the substrate, the holding assembly having a central area with a periphery around the central area and having switchable electromagnets that are spaced apart from each other around the periphery;
a first movement device for moving the holding assembly relative to the substrate; and
a second movement device for moving the substrate towards the holding assembly of the mask in a direction perpendicular to the surface of the substrate.

9. The device of claim 8, wherein at least one of the first and second movement devices comprises a spindle drive.

10. The device of claim 8, wherein the first movement device comprises at least two independent linear drives or at least a rotary drive for lateral alignment of the holding assembly or the mask.

11. The device of claim 8 further comprising a monitoring and control device for determining lateral alignment of the mask with the substrate, the monitoring and control device having at least one CCD camera.

12. The device of claim 8, further comprising a mounting wall arranged for mounting the device to a chamber wall in a vacuum chamber.

13. The device of claim 8, further comprising a substrate-carrier holding position at which a substrate carrier for holding and transporting the substrate through a coating machine can be arranged in a pre-defined transfer position in the holding assembly.

14. The device of claim 13, wherein the substrate-carrier holding position is constructed and arranged such that magnets of the substrate carrier lie opposite the electromagnets of the holding assembly.

15. The device of claim 8, wherein the device is constructed and arranged such that magnets of a substrate carrier and the electromagnets of the holding assembly are aligned with each other, and wherein the device is configured to switch the electromagnets on and off to deposit the mask on the substrate carrier, and remove the mask from the substrate carrier.

16. The device of claim 8, wherein the holding assembly comprises a holding plate or a rectangular, polygonal or annular holding frame, on one side of which contains the electromagnets and an opposite side of which is coupled to the first movement device.

17. The device of claim 8, wherein the magnets of the substrate carrier are arranged equidistantly from each other.

18. The device of claim 8, wherein the second movement device comprises at least one coupling element for releasably gripping the substrate carrier.

19. The device of any of claim 8, wherein the second movement device comprises several means for moving the substrate.

20. The device of claim 8, in combination with a vacuum-coating machine that receives the substrates and masks and coats the substrates with electroluminescent materials.

21. The device of claim 8, wherein the first movement device comprises at least two independent linear drives and a rotary drive for lateral alignment of the holding assembly or the mask.
